(19) United States
(12) Patent Application Publication
(10) Pub. No.: US 2022/0355920 A1
(43) Pub. Date: Nov. 10, 2022

(54) TENSION TORSION STRAP WITH ARCHED WINDING PATTERN

(71) Applicant: LORD Corporation, Cary, NC (US)

(72) Inventor: Mark Smialowski, Erie (US)

(21) Appl. No.: 17/765,123

(22) PCT Filed: Oct. 21, 2020
(86) PCT No.: PCT/US2020/056569

§ 371 Date: Mar. 30, 2022

Related U.S. Application Data
(60) Provisional application No. 62/923,845, filed on Oct. 21, 2019.

(51) Int. Cl. B64C 27/33; B64C 27/48

(52) U.S. Cl. CPC B64C 27/33; B64C 27/48

(57) ABSTRACT

A tension-torsion strap includes a first spindle and a second spindle, which are spaced apart from each other, such that the first and second spindles are positioned at opposite ends of the tension-torsion strap, a winding formed of a filament wrapped about the first and second spindles a plurality of turns, the winding extending between and connecting the first and second spindles and being positioned within a cavity formed circumferentially about each of the first and second spindles, and a protective layer covering the winding, which is formed according to an arched winding pattern, a portion of the winding extending outside boundaries of the cavity defined by the inner wall and the lateral walls, such that an outer surface of the winding has an arched, or curved, profile.

### CROSS-REFERENCE TO RELATED APPLICATION

This application claims priority to U.S. Provisional Patent Application Ser. No. 62/923,845, filed Oct. 21, 2019, the disclosure of which is incorporated herein by reference in its entirety.

### TECHNICAL FIELD

The subject matter disclosed herein relates to tension-torsion straps for rotatably securing a rotatable member (e.g., a rotary blade) to a rotary hub, for example, on a helicopter.

### BACKGROUND

Known tension-torsion straps (“TT straps”) or “tie bars” used as parts of helicopter blade retention systems have a rectangular wire winding package that is defined by the contours of a corresponding rectangularly-shaped cross-sectional area defined in one or more support elements, but are designed to fit within and be operable in a cylindrically-shaped space. The winding package is sealed with an elastomeric covering layer that protects the winding from damage, corrosion, and the like during normal operation.

However, it is advantageous to reduce the physical size and, accordingly, the mass of tension-torsion straps to reduce a size of the tie bar and, accordingly, the mass being rotated about the hub and the mass of the overall helicopter. While the focus of size and weight reduction has focused historically on using stronger and/or lighter materials for the winding package, a need exists to continue to minimize the size and mass of the tie bars.

### SUMMARY

In a first example aspect, a tension-torsion strap is disclosed herein, the tension-torsion strap comprising a first spindle and a second spindle, the first spindle being spaced apart from the second spindle by a predefined distance, the predefined distance and a diameter of each of the first and second spindles, respectively, defining a length of the tension-torsion strap, such that the first and second spindles are positioned at opposite ends of the tension-torsion strap; a winding comprising a filament wrapped about the first and second spindles a plurality of turns, the winding extending between and connecting the first and second spindles and being positioned within a cavity formed circumferentially about each of the first and second spindles, wherein a width of each cavity is defined by lateral walls that are attached to an inner wall of each of the first and second spindles, respectively, and extend radially away from the inner wall to which each such lateral wall is attached; and a protective layer covering the winding; wherein the winding is formed according to an arched winding pattern, a portion of the winding extending outside boundaries of the cavity defined by the inner wall and the lateral walls, such that an outer surface of the winding has an arched, or curved, profile.

In some embodiments of the tension-torsion strap, the outer surface of the winding is a surface that is not defined by the lateral walls and the inner wall of the spindles.

In some embodiments of the tension-torsion strap, according to the arched winding pattern, for each successively deposited layer of the winding, a number of turns about which the filament is wound about the first and second spindles is the same or fewer as an immediately previously deposited layer of the winding.

In some embodiments of the tension-torsion strap, according to the arched winding pattern, for each successively deposited layer of the winding, a number of turns about which the filament is wound about the first and second spindles is the same or fewer as all previously deposited layers of the winding.

In some embodiments of the tension-torsion strap, each successively deposited layer of the winding is further spaced apart from the inner wall that all previously deposited layers of the winding.

In some embodiments of the tension-torsion strap, the tension-torsion strap is configured to be inserted in an internal space within a blade-hub coupler on a rotary machine, and wherein the outer surface of the winding has a profile that is substantially similar to an inner surface of the internal space within the blade-hub coupler.

In some embodiments of the tension-torsion strap, the rotary machine comprises a helicopter or other rotary-driven aircraft.

In some embodiments of the tension-torsion strap, at least a portion of the winding extends radially beyond the sidewalls of one or both of the first and second spindles.

In some embodiments of the tension-torsion strap, the protective layer comprises an elastomeric material.

In some embodiments of the tension-torsion strap, the protective layer is a molded layer surrounding at least a portion of the first and second spindles and at least a portion of the winding.

In some embodiments of the tension-torsion strap, the filament comprises a metallic wire or an organic fiber.

In a second example aspect, a method of forming a tension-torsion strap is disclosed, the method comprising arranging a first spindle and a second spindle to have a predefined distance therebetween, the predefined distance and a diameter of each of the first and second spindles, respectively, defining a length of the tension-torsion strap, such that the first and second spindles are positioned at opposite ends of the tension-torsion strap; wrapping a filament about the first and second spindles a plurality of turns to form a winding, wherein the winding extends between and connects the first and second spindles and is positioned within a cavity formed circumferentially about each of the first and second spindles, and wherein a width of each cavity is defined by lateral walls that are attached to an inner wall of each of the first and second spindles, respectively, and extend radially away from the inner wall to which each such lateral wall is attached; and covering at least the winding with a protective layer; wherein the winding is formed according to an arched winding pattern, a portion of the winding extending outside boundaries of the cavity defined by the inner wall and the lateral walls, such that an outer surface of the winding has an arched, or curved, profile.

In some embodiments of the method, the outer surface of the winding is a surface that is not defined by the lateral walls and the inner wall of the spindles.

In some embodiments, the method comprises, according to the arched winding pattern, winding the filament, for each successively deposited layer of the winding, about the first and second spindles the same or fewer number of turns as an immediately previously deposited layer of the winding.

In some embodiments, the method comprises, according to the arched winding pattern, winding the filament, for each successively deposited layer of the winding, about the first and second spindles the same or fewer number of turns as all previously deposited layers of the winding.

In some embodiments of the method, each successively deposited layer of the winding is further spaced apart from the inner wall that all previously deposited layers of the winding.

In some embodiments of the method, the tension-torsion strap is inserted in an internal space within a blade-hub coupler on a rotary machine, and wherein the outer surface of the winding has a profile that is substantially similar to an inner surface of the internal space within the blade-hub coupler.

In some embodiments of the method, the rotary machine comprises a helicopter or other rotary-driven aircraft.

In some embodiments of the method, at least a portion of the winding extends radially beyond the sidewalls of one or both of the first and second spindles.

In some embodiments of the method, the protective layer comprises an elastomeric material.

In some embodiments of the method, the protective layer is a molded layer surrounding at least a portion of the first and second spindles and at least a portion of the winding.

In some embodiments of the method, the filament comprises a metallic wire or an organic fiber.

### BRIEF DESCRIPTION OF THE DRAWINGS

FIG. 1 is a schematic cross-sectional view of a tension-torsion strap having a conventional winding pattern as known in the prior art.

FIG. 2 is a schematic cross-sectional view of an example first embodiment of a tension-torsion strap having a winding channel of substantially the same size as in the prior art tension-torsion strap of FIG. 1, but further utilizing an arched winding pattern to increase a strength of the tension-torsion strap.

FIG. 3 is a schematic cross-sectional view of an example second embodiment of a tension-torsion strap having a winding channel of a reduced size, but substantially similar cross-sectional area, compared to the prior art tension-torsion strap of FIG. 1.

FIG. 4A is a schematic cross-sectional view comparing the cross-sectional sizes of the embodiment of FIG. 3, shown in solid line, with the prior art tension-torsion strap of FIG. 1, shown in broken line, to illustrate the reduced size of the tension-torsion strap that can be achieved.

FIG. 4B is alternate embodiment schematic cross-sectional view comparing the cross-sectional sizes of the embodiment of FIG. 3, shown in solid line, with the prior art tension-torsion strap of FIG. 1, shown in broken line, to illustrate the reduced size of the tension-torsion strap that can be achieved

FIG. 5 is a partially internal view of a system for coupling a rotating blade to a rotary hub, as in a helicopter in the example embodiment shown, the system having at least one tension-torsion strap according to one of FIG. 2 or 3.

FIG. 6 is a perspective view of a simplified tension-torsion strap known according to the prior art.

FIG. 7 is an isometric view of a further example embodiment of a tension-torsion strap having the arched winding pattern shown in FIGS. 2-4.

FIG. 8 is a side view of the tension-torsion strap of FIG. 7.

FIG. 9 is a top view of the tension-torsion strap of FIG. 7.

FIG. 10 is a cross-sectional view, taken along the cut plane 10-10 of FIG. 9, of the tension-torsion strap of FIG. 7.

FIGS. 11A, 11B and 11C are cross-sectional views, taken along the cut plane 11-11 of FIG. 9, of the tension-torsion strap of FIG. 7.

FIG. 12 is a cross-sectional view, taken along the cut plane 11-11 of FIG. 9, of the example embodiment of the tension-torsion strap of FIG. 7.

FIG. 13 is an isometric cross-sectional view, taken along the cut plane 13-13 of FIG. 9, of the example embodiment of the tension-torsion strap of FIG. 7.

FIG. 14 is a partial sectional view, taken along the cut plane 10-10 of FIG. 8 and the cut plane 13-13 of FIG. 9, of the tension-torsion strap of FIG. 7.

### DESCRIPTION

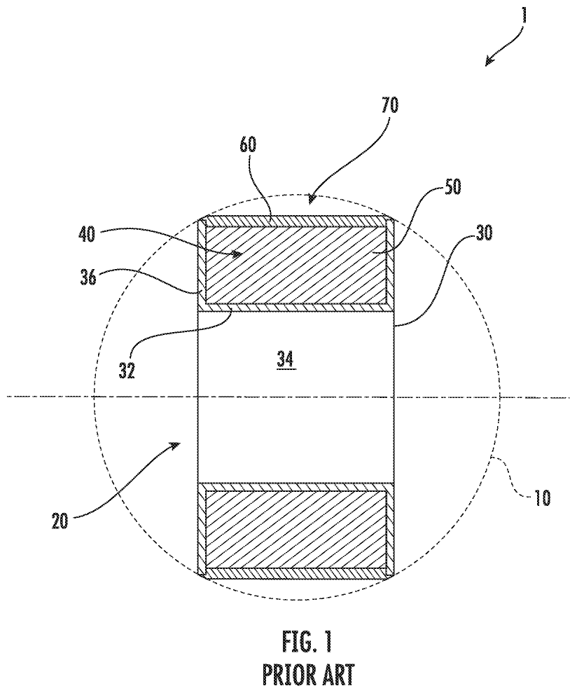

Various example embodiments of a tension-torsion strap (“TT strap”) for connecting a rotatable blade to a rotary hub, for example, in a helicopter or propeller-driven aircraft application, are disclosed herein. An example of a prior art rotary coupler, generally designated 1, comprising a conventional TT strap, generally designated 20, known from the prior art is shown in the cross-sectional view of FIG. 1. As shown, in forming the rotary coupler 1, the TT strap 20 is inserted longitudinally through a generally cylindrically-shaped internal space formed by the blade-hub coupler 10. According to this example embodiment, the TT strap 20 comprises spindles 30 arranged on opposite ends of the TT strap 20, spaced apart from each other in the longitudinal direction of both the TT strap 20 and the internal space of the blade-hub coupler 10, such that the spindles 30 substantially define a length of the TT strap 20.

The view shown in FIG. 1 is taken through a midpoint of one of the spindles 30, in a plane substantially perpendicular to the longitudinal axis of the TT strap 20. The spindles 30 are generally annularly-shaped member having an annular inner wall 32 that defines a through-hole 34, with lateral walls 36 extending away from the inner wall 32 (e.g., in the radial direction of the spindle 30), such that a cavity, generally designated 40, is defined on at least three sides by the inner wall 32 and the lateral walls 36, with the fourth side being defined by the plane passing through the respective ends of the lateral walls 36 opposite where the lateral walls are attached to the inner wall 32. The conventional TT strap 20 is formed such that the cavity 40 has a generally rectangular cross-sectional profile, or area, in which a winding 50 is arranged. The winding 50 is made up of one or more filaments of a wire (e.g., a member having a substantially infinite length, in comparison with the cross-sectional area thereof) wrapped about the spindles 30 by a predetermined number of times, or turns. As such, the winding 50 substantially entirely fills the cavity 40 of the TT strap 20 (e.g., except for allowing for air gaps between adjacent portions of the filament, which will commonly have a circular cross-sectional area). The TT strap 20 is encased, either entirely or at least partially, by a protective layer 60, which encases the winding 50 and protects the winding from damage (e.g., due to handling, environmental corrosion, impacts, and the like).

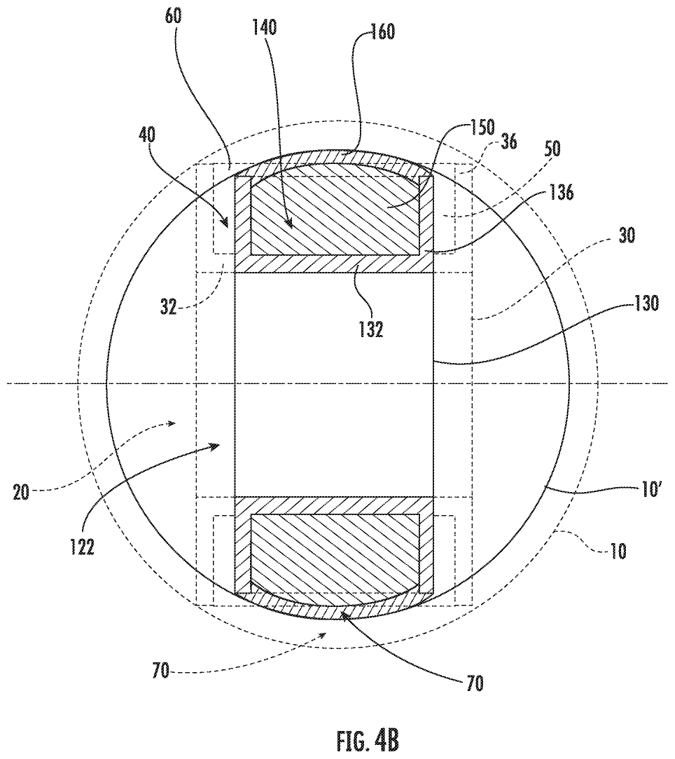

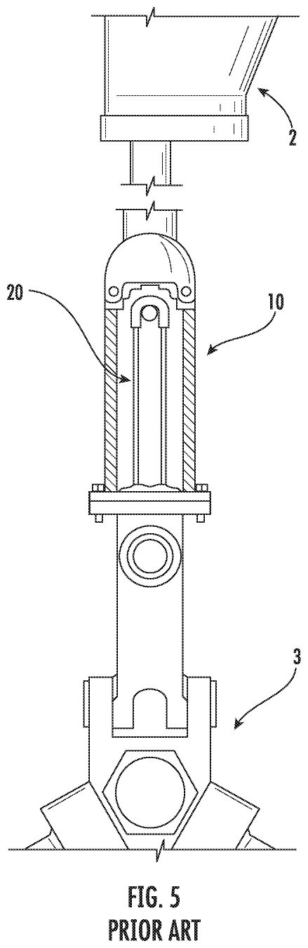

The prior art rotary coupler 1 is shown as a part of a blade-hub coupler (e.g., as in a helicopter or other rotary aircraft), according to the prior art, in FIGS. 5 and 6. As noted herein, FIG. 1 is a cross-sectional view of such a rotary coupler 1 having a conventionally designed TT strap 20 installed within a cavity of a blade-hub coupler 10. As shown in FIG. 5, the blade-hub coupler 10 is attached between the blade, generally designated 2, and the hub, generally designated 3, of the rotary aircraft. As noted herein, the winding 50 is retained at the spindles 30 within a cavity 40 having a generally rectangular cross-sectional shape and extending circumferentially about at least half (e.g., about at least)180° of the spindle 30, such that the winding 50 has a substantially identical rectangular shape to that of the cavity 40 in which the winding 50 is formed. The winding 50 is encased within the cavity 40 by a protective layer 60 which can be, for example, made of a dispensable elastomeric material, including, for example, urethane. In each of FIGS. 1-4B, the inner contours (e.g., internal surface) of the internal space within the blade-hub coupler 10 in which the TT strap (e.g., 20, 120) are denoted by the circle shown in broken line. As can be seen in FIG. 1, there exists a region 70 extending in the radial direction beyond the cavity 40 (e.g., towards the internal surface of the blade-hub coupler 10) in which no winding 50 is located, but which would nevertheless fit within the volumetric region of the internal space within the blade-hub coupler 10.

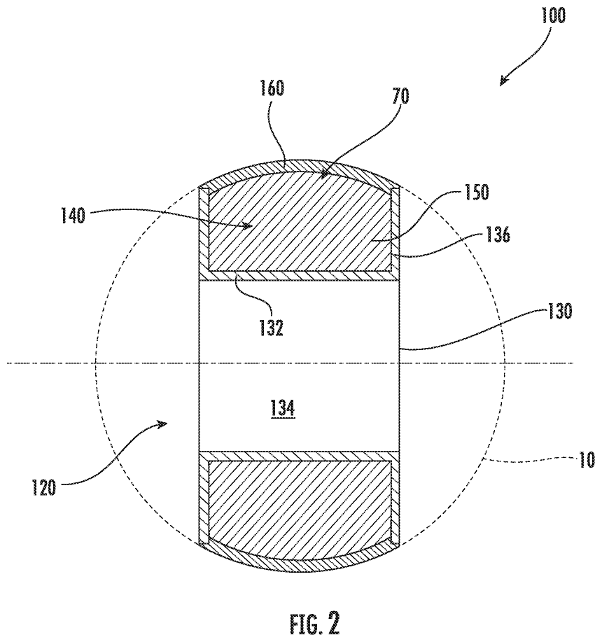

FIG. 2 is a cross-sectional view of an example embodiment of a TT strap, generally designated 120, according to the disclosure herein installed within a blade-hub coupler 10 to form an example embodiment of a rotary coupler, generally designated 100, according to the disclosure herein. As shown, in forming the rotary coupler 100, the TT strap 120 is inserted longitudinally through a generally cylindrically-shaped internal space formed by the blade-hub coupler 10. According to this example embodiment, the TT strap 120 comprises spindles 130 arranged on opposite ends of the TT strap 120, spaced apart from each other in the longitudinal direction of both the TT strap 120 and the internal space of the blade-hub coupler 10, such that the spindles 130 substantially define a length of the TT strap 120.

The view shown in FIG. 2 is taken through a midpoint of one of the spindles 130, in a plane substantially perpendicular to the longitudinal axis of the TT strap 120. The spindles 130 are generally annularly-shaped members having an annular inner wall 132 that defines a through-hole 134, with lateral walls 136 extending away from the inner wall 132 (e.g., in the radial direction of the spindle 130), such that a cavity, generally designated 140, is defined on at least three sides by the inner wall 132 and the lateral walls 136, with the fourth side being defined by the plane passing through the respective ends of the lateral walls 136 opposite where the lateral walls are attached to the inner wall 132. The example TT strap 120 is formed such that the cavity 140 has a generally rectangular cross-sectional profile, or area, in which a winding 150 is partially arranged (e.g., so as to extend out from and into at least a portion of the region 70).

The winding 150 is made up of one or more filaments of a wire (e.g., a member having a substantially infinite length, in comparison with the cross-sectional area thereof) wrapped about the spindles 130 by a predetermined number of times, or turns. As such, the winding 150 substantially entirely fills the cavity 140 of the TT strap 120 (e.g., except for allowing for air gaps between adjacent portions of the filament, which will commonly have a circular cross-sectional area) and also at least a portion of the region 70. The TT strap 120 is encased, either entirely or at least partially, by a protective layer 160, which encases (e.g., entirely, or fully, encases) the winding 150 and protects the winding 150 from damage (e.g., due to handling, environmental corrosion, impacts, and the like). In some embodiments, a portion of the winding 150 and a portion of the protective layer 160 substantially entirely fill (e.g., at least 80%, at least 90%, at least 95%, or at least 99%) the region 70 that is left vacant in prior art rotary couplers (e.g., 1, FIG. 1).

As shown, the TT strap 120 is shaped such that the upper contour of the winding 150 has an arched, or curved, shape, such that the outermost layer of the winding 150, as well as the protective layer, occupies the region 70 extending in the radial direction beyond the cavity in the prior art TT strap 20 (e.g., FIG. 1) and has a contour substantially identical to the inner surface of the internal space of the blade-hub coupler 10 in which the TT strap 20 is positioned for use in coupling a blade (e.g., 2, FIG. 5) to a hub (e.g., 3, FIG. 5). The winding 150 can be formed of one or more filaments of conventional materials. During manufacture of the TT strap 120, the position of the wire dispenser is indexed (e.g., moved in the direction of the width of the inner wall 32, as shown in FIG. 2) by the thickness, or diameter, of the filament used in forming the winding 150 after each full rotation of the winding dispenser relative to the TT strap 120, or vice-versa. As such, each “layer” of the winding 150 is dispensed (e.g., wrapped about the spindles by one full revolution) prior to a subsequent “layer” of the winding 150 being dispensed. As used herein, the term “layer” is used to refer to coplanar filaments of the winding 150 that are parallel to the inner wall 32 shown in FIG. 2. When a sufficient number of layers of the winding 150 have been dispensed such that the height of the winding 150 is at least a height within the cavity 140 at which the arched profile in the region 70 needs to be generated so that the outer contour of the TT strap 120 (e.g., the portion of the protective layer 160 covering the outer surface of the winding 150) is substantially the same shape as the inner surface of the internal space of the blade-hub coupler 10, the winding dispenser is indexed in the same manner as described hereinabove in forming the portion of the winding 150 contained within the cavity 140, but starts and stops each layer of the winding 150 that is within the region 70 at a position away from the lateral walls 136 of the spindle 130, such that, for each subsequent layer of the winding dispensed within the region 70, the layer comprises a same or less number of windings of the filament as in a previously deposited layer of the winding 150, thereby resulting in the arched outer profile.

For example, the first layer of the winding 150 that is outside of the cavity 140 may have the same or less number of filament windings as the last layer of the winding that is inside (e.g., at the top of) the cavity 140. Similarly, the second layer of the winding 150 that is outside of the cavity 140 may have the same or less number of filament windings as the first layer of the winding 150 that is outside of the cavity 140. As such, each subsequently dispensed layer of the winding 150 within the region 70 has a same or fewer number of filament windings as the immediately preceding layer of the winding 150. In some embodiments, each subsequently dispensed layer of the winding 150 within the region 70 has a same or fewer number of filament windings as all of the preceding layers of the winding 150. Thus, rather than the region 70 being vacant, as is the case in prior art TT straps, the region 70 can be occupied by the winding 150 and, accordingly, the tensile and/or torsional strength of the TT strap 120 will be greater than the prior art TT strap 20 (see FIG. 1) without having to increase the size (e.g., the diameter) of the internal space of the blade-hub coupler 10 in which the novel TT strap 120 disclosed herein will be positioned, thereby allowing for the use of a TT strap 120 having higher strength in a blade-hub coupler 10 of a same size. In some embodiments, the winding comprises a metallic wire or an organic material (e.g., a filament comprising carbon nanotubes).

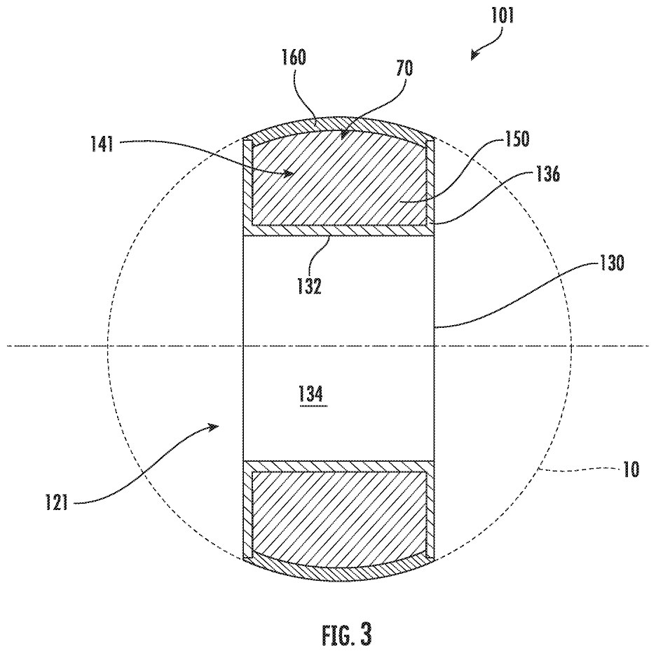

FIG. 3 is a cross-sectional view of a second example embodiment of a TT strap, generally designated 121, according to the disclosure herein, which is installed within a blade-hub coupler 10 to form an example embodiment of a rotary coupler, generally designated 101, according to the disclosure herein. As shown, in forming the rotary coupler 101, the TT strap 121 is inserted longitudinally through a generally cylindrically-shaped internal space formed by the blade-hub coupler 10. According to this example embodiment, the TT strap 121 comprises spindles 130 arranged on opposite ends of the TT strap 121, spaced apart from each other in the longitudinal direction of both the TT strap 121 and the internal space of the blade-hub coupler 10, such that the spindles 130 substantially define a length of the TT strap 121.

The view shown in FIG. 3 is taken through a midpoint of one of the spindles 130, in a plane substantially perpendicular to the longitudinal axis of the TT strap 121. The spindles 130 are generally annularly-shaped members having an annular inner wall 132 that defines a through-hole 134, with lateral walls 136 extending away from the inner wall 132 (e.g., in the radial direction of the spindle 130), such that a cavity, generally designated 141, is defined on at least three sides by the inner wall 132 and the lateral walls 136, with the fourth side being defined by the plane passing through the respective ends of the lateral walls 136 opposite where the lateral walls are attached to the inner wall 132. The example TT strap 121 is formed such that the cavity 141 has a generally rectangular cross-sectional profile, or area, in which a winding 150 is partially arranged (e.g., so as to extend out from and into at least a portion of the region 70).

The winding 150 is made up of one or more filaments of a wire (e.g., a member having a substantially infinite length, in comparison with the cross-sectional area thereof) wrapped about the spindles 130 by a predetermined number of times, or turns. As such, the winding 150 substantially entirely fills the cavity 140 of the TT strap 121 (e.g., except for allowing for air gaps between adjacent portions of the filament, which will commonly have a circular cross-sectional area) and also at least a portion of the region 70. The TT strap 121 is encased, either entirely or at least partially, by a protective layer 160, which encases (e.g., entirely, or fully, encases) the winding 150 and protects the winding 150 from damage (e.g., due to handling, environmental corrosion, impacts, and the like). In some embodiments, a portion of the winding 150 and a portion of the protective layer 160 substantially entirely fill (e.g., at least 80%, at least 90%, at least 95%, or at least 99%) the region 70 that is left vacant in prior art rotary couplers (e.g., 1, FIG. 1).

It should be noted that the images shown in the figures are not necessarily drawn to scale, but are provided to illustrate the concept that, by extending the winding 150 to occupy the entirety of the space both within the cavity 141 and the region 70, between the inner surface of the internal space of the blade-hub coupler 10 and the upper edge of the cavity 141, the overall size of the TT strap 121 may be reduced relative to a conventionally known TT strap (e.g., 20, FIG. 1), whether by reducing a width of the spindle 130 and/or cavity 141, reducing a height of the lateral walls 136 and/or cavity 141, or any possible combination thereof. As shown in FIG. 3, the cavity 141 is smaller both in height and width than the cavity 40, 140 in either of the example embodiments shown in FIGS. 1 and 2, but the winding 150 extends to occupy the entirety of the cavity 141 and also of the region 70. FIG. 3 shows the diameter of the through-hole 134 by which the TT strap 121 is secured within the blade-hub coupler 10 being increased, but it can be advantageous to maintain the diameter of the through-hole 134 in the embodiment of FIG. 3 to be the same diameter as the through-hole 34 in the prior art example shown in FIG. 1, thereby allowing for the outer diameter of the TT strap 121 and, accordingly, the inner diameter of the internal space within the blade-hub coupler 10 to be reduced, as compared to the prior art rotary coupler 1, to reduce the size and/or mass of the blade-hub coupler 10 . As shown, since the cross-sectional area of the winding 150 is substantially the same in the TT straps 20, 121 shown in FIGS. 1 and 3, respectively, the TT strap 121 of FIG. 3 can carry centripetal force loads between the blade (e.g., 2, FIG. 5) and the hub (e.g., 3, FIG. 5) in a smaller space and/or blade-hub coupler 10, thereby resulting in a reduction of the overall mass and torsional stiffness of the TT strap 121 and/or rotary coupler 101 shown in FIG. 3 as compared to the TT strap 20 and/or rotary coupler 1 shown in FIG. 1.

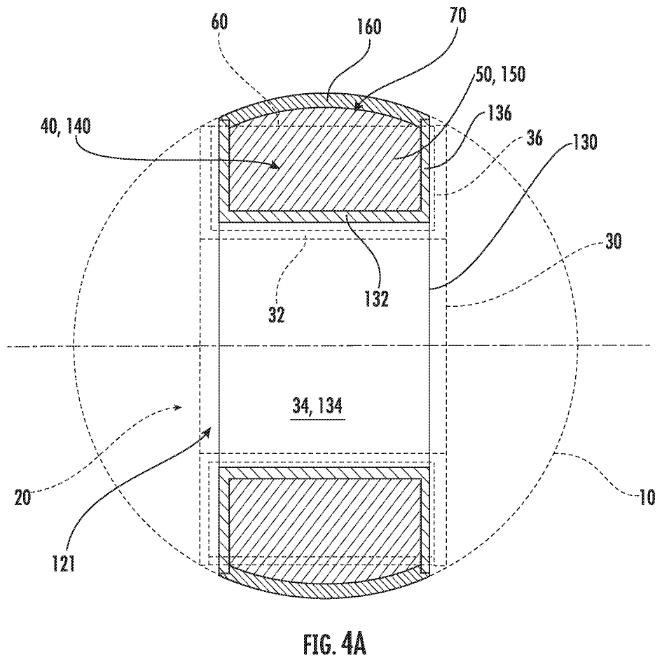

FIG. 4A is a cross-sectional view of the TT strap 121 of the embodiment in FIG. 3, over which a traditional TT strap 20, such as is shown in FIG. 1, is overlaid in broken lines to illustrate the reduction in size of such a TT strap 121 that can be achieved using such an arched winding pattern so that the winding 151 of the TT strap 121 has a curved outer surface that substantially conforms with the contour of the inner surface of the internal space of the blade-hub spacer 10 in which the TT strap 121 is installed. FIG. 4B is a cross-sectional view of an example embodiment of a TT strap, generally designated 122, which is an alternate embodiment of the TT strap 121 of the example embodiment in FIG. 3. In this example embodiment, the internal space of the blade-hub coupler 10′ is shown in solid line as being reduced, relative to the internal space of the blade-hub coupler 10, shown in broken line, that is necessary to accommodate the prior art TT strap 20 therein. The TT strap 121 uses a different spindle 130 compared to the spindle 30 of the prior art TT strap 20. It should be noted that the reductions in size may not be drawn to scale in order to more clearly illustrate the benefits of the example TT straps disclosed herein. As such, the reduction in size of the internal space of the blade-hub coupler 10′ compared to the blade-hub coupler 10 may be exaggerated in an attempt to avoid overlapping solid and broken lines in FIG. 4B. The spindles 30, 130 have a same diameter through-hole 34, 134, so that a same fastener can be used to attach the TT straps 20, 121 to a blade (e.g., 2, FIG. 5) and hub (e.g., 3, FIG. 5). In order that the TT strap 121 has a same tensile and/or torsional strength as the TT strap 20, the number of turns in the winding 150 is substantially similar to the winding 50 and/or the volume of the winding 150 is substantially similar to the winding 50.

In some embodiments, the spindle 130 has a narrower (e.g., in the direction of the through-hole 134) inner wall 132 than the inner wall 32 of the spindle 30 and/or the spindle 130 has shorter (e.g., in the vertical direction, as shown in FIG. 4B) side walls 136 than the side walls 36 of the spindle 30.

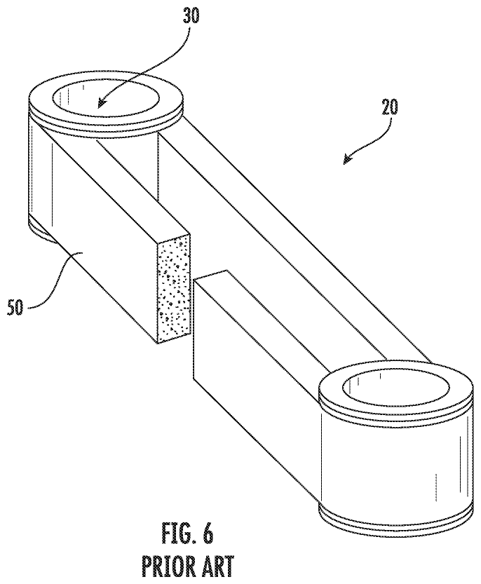

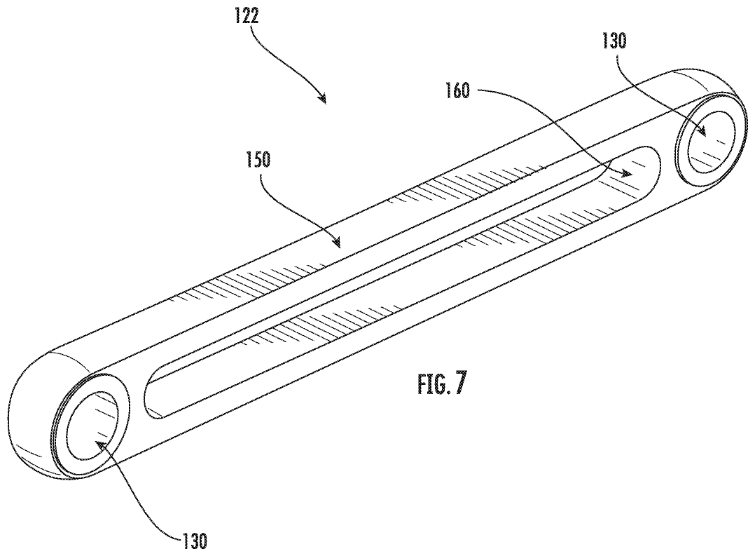

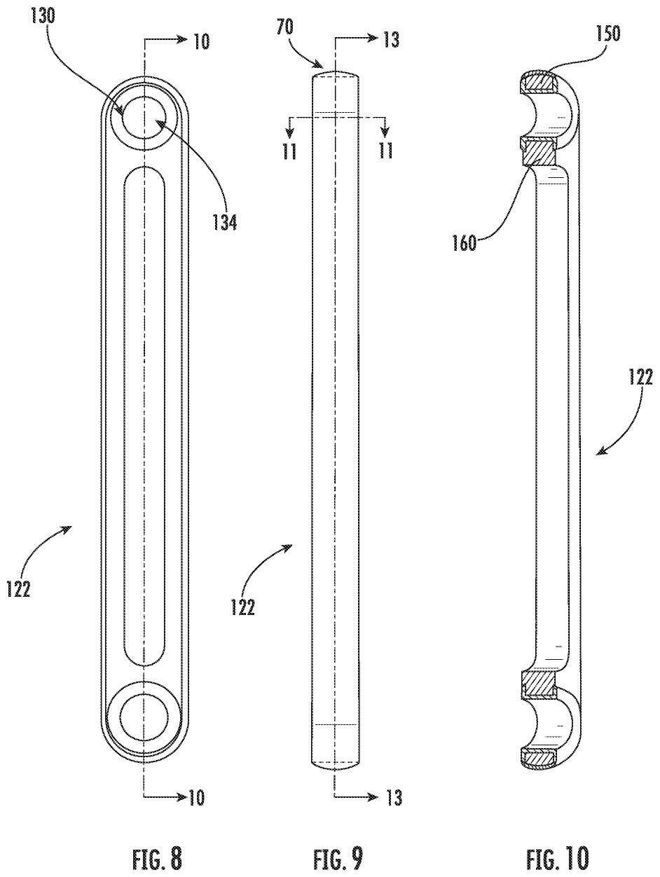

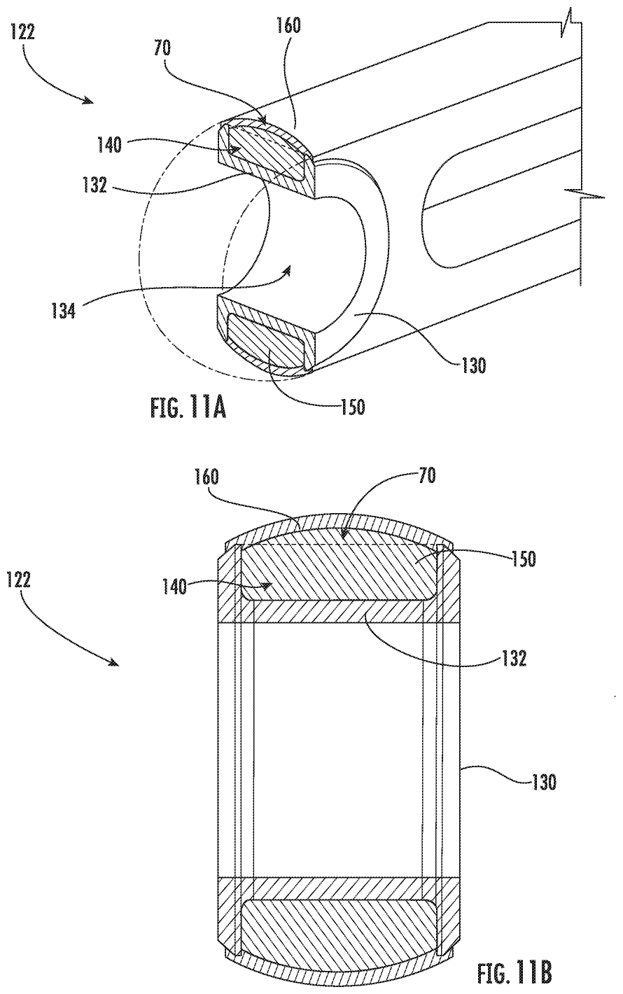

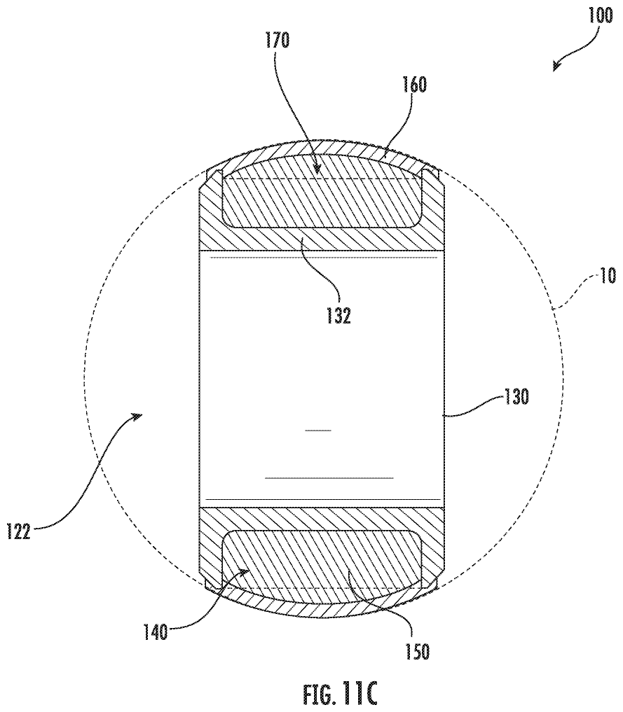

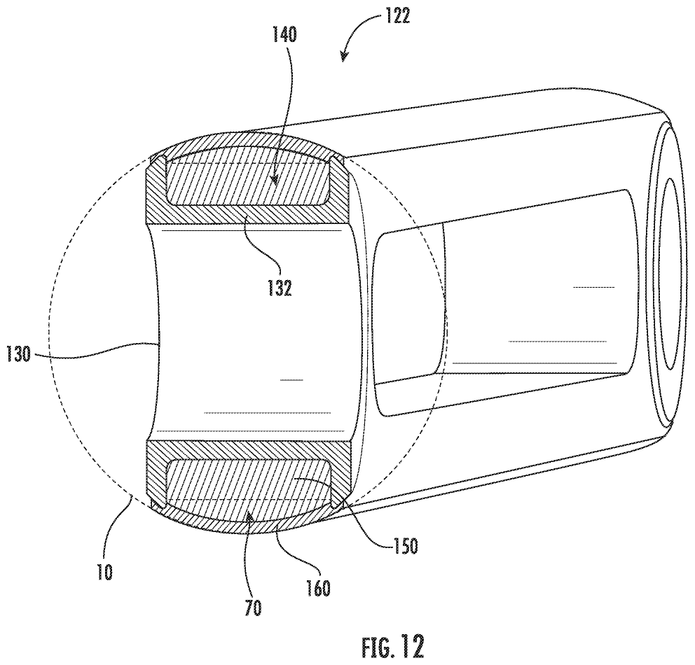

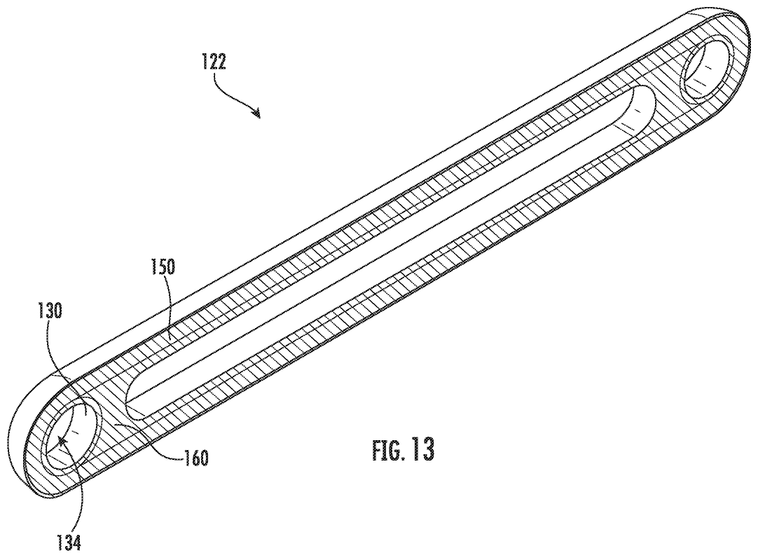

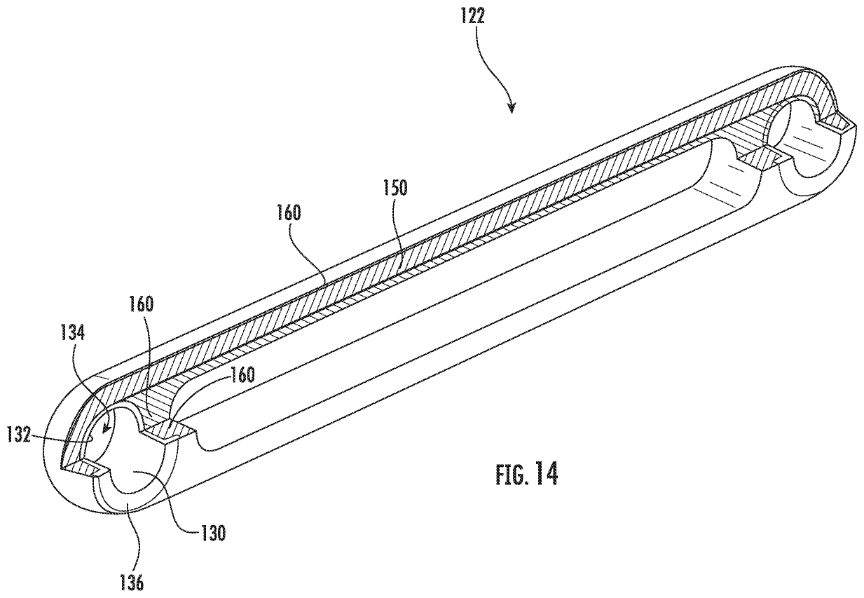

FIGS. 7-14 show various views of another example embodiment of a TT strap, generally designated 122, according to the disclosure herein, the winding 150 of which was created using an arched winding pattern (e.g., generally similar to that shown in TT straps 120, 121 of FIGS. 2 and 3). The TT strap 122 is an example of a lightweight connection member capable of transmitting high tensile and torsional loadings between two structures, such as a rotor hub (e.g., 3, FIG. 5) and a blade (e.g., 2, FIG. 5) that is rotatable about the hub. The TT strap 122 is a structure that can be used as an attachment between structures, such as a blade (e.g., 2, FIG. 5) and a hub (e.g., 3, FIG. 5) to be coupled together, in particular to a blade root and rotor hub member through appropriate pin connection(s) (e.g., through through-holes 134). As shown, the TT strap 122 is a laminated coupling that includes a pair of spaced apart spindles 130 (e.g., in the form of end bushings), each of which includes a through-hole 134 extending therethrough (e.g., through a thickness of, as defined by the inner wall 132 of the spindle 130) to receive an attachment (e.g., in the form of a longitudinally extending pin, or any other suitable type of fastener) of one of the structures for securing the TT strap within the surrounding structure (e.g., within the blade-hub coupler 10. Each of the spindles 130 includes, extending radially away from the edges of the inner wall 132, first and second lateral walls 136, in the form generally of an upper flange and a lower flange, respectively, which, together with the inner wall 132, define a cavity (e.g., in the form of a channel) around the periphery of the spindles 130 that receive a portion (e.g., an end portion) of the winding 150 that extends continuously around each of the spindles 130. The winding 150 comprises a plurality of layers of filament(s) that can be unified (e.g., joined together and/or prevented from becoming unwound during use) by an encapsulating protective layer 160.

In the TT strap 122, the winding 150 is formed about the spindles 130 that are located at opposite ends of the TT strap 122. The windings are encased within a molded protective cover 160, which can be any suitable material, including, for example, an elastomeric material, and secures the spindles 130 and the winding 150 together, thereby forming a TT strap 122 having a generally unitary, or integrally formed, construction. The winding 150 extends between and around the spindles 130, the winding 150 being generally secured within the cavity 140 of the spindle 130, as formed by the inner wall 132 and the lateral walls 136. Due to the molding of the protective layer 160 over the spindles 130 and the winding 150, the protective layer 160 infiltrates within the cavity 140 of each of the spindles 120 in positions about the spindles 130 at which the winding 150 is not within the cavity 140 and/or is not in contact with the spindles 130. In some embodiments, the protective layer 160 may be injection molded at a sufficiently high pressure and/or may be made from a material having a sufficiently low uncured viscosity so that the protective layer 160 at least partially or entirely infiltrates between the individual filaments forming the winding 150. In some embodiments, the cavity 140 has both at least a portion of the winding 150 and a portion of the protective layer 160 contained therein. In some embodiments, the cavity 140 can be substantially entirely filled with the protective layer 160 and the winding 150, and/or is substantially devoid of voids (e.g., air pockets) between adjacent filament windings of the winding 150.1 some embodiments, the entirety of the winding 150 is covered, or encapsulated, by the protective layer 160, such that no portion of the winding 150 is externally visible when the TT strap 122 is viewed from any angle. As shown, the portion of the winding 150 that extends (e.g., within the region 70) outside of the cavity 140 defined by the inner wall 132 and the lateral walls 136 of the spindles 130 gives the TT strap 122 an arched outer profile over (e.g., directly over) the winding 150, so that one or more of the outer surfaces of the TT strap 122 have a curved outer profile.

The present subject matter can be embodied in other forms without departing from the spirit and essential characteristics of the subject matter described with respect to the example embodiments described herein. The embodiments described therefore are to be considered in all respects as illustrative and not restrictive. Although the present subject matter has been described in terms of certain example embodiments, other embodiments that are apparent to those of ordinary skill in the art are also included within the scope of the presently disclosed subject matter.

What is claimed is:

1. A tension-torsion strap comprising:
a first spindle and a second spindle, the first spindle being spaced apart from the second spindle by a predefined distance, the predefined distance and a diameter of each of the first and second spindles, respectively, defining a length of the tension-torsion strap, such that the first and second spindles are positioned at opposite ends of the tension-torsion strap;
a winding comprising a filament wrapped about the first and second spindles a plurality of turns, the winding extending between and connecting the first and second spindles and being positioned within a cavity formed circumferentially about each of the first and second spindles, wherein a width of each cavity is defined by lateral walls that are attached to an inner wall of each of the first and second spindles, respectively, and extend radially away from the inner wall to which each such lateral wall is attached; and
a protective layer covering the winding;
wherein the winding is formed according to an arched winding pattern, a portion of the winding extending outside boundaries of the cavity defined by the inner wall and the lateral walls, such that an outer surface of the winding has an arched, or curved, profile.

2. The tension-torsion strap of claim 1, wherein the outer surface of the winding is a surface that is not defined by the lateral walls and the inner wall of the spindles.

3. The tension-torsion strap of claim 1, wherein, according to the arched winding pattern, for each successively deposited layer of the winding, a number of turns about which the filament is wound about the first and second spindles is the same or fewer as an immediately previously deposited layer of the winding.

4. The tension-torsion strap of claim 1, wherein, according to the arched winding pattern, for each successively deposited layer of the winding, a number of turns about which the filament is wound about the first and second spindles is the same or fewer as all previously deposited layers of the winding.

5. The tension-torsion strap of claim 4, wherein each successively deposited layer of the winding is further spaced apart from the inner wall that all previously deposited layers of the winding.

6. The tension-torsion strap of claim 1, wherein the tension-torsion strap is configured to be inserted in an internal space within a blade-hub coupler on a rotary machine, and wherein the outer surface of the winding has a profile that is substantially similar to an inner surface of the internal space within the blade-hub coupler.

7. The tension-torsion strap of claim 6, wherein the rotary machine comprises a helicopter or other rotary-driven aircraft.

8. The tension-torsion strap of claim 1, wherein at least a portion of the winding extends radially beyond the sidewalls of one or both of the first and second spindles.

9. The tension-torsion strap of claim 1, wherein the protective layer comprises an elastomeric material.

10. The tension-torsion strap of claim 1, wherein the protective layer is a molded layer surrounding at least a portion of the first and second spindles and at least a portion of the winding.

11. The tension-torsion strap of claim 1, wherein the filament comprises a metallic wire or an organic fiber.

12. A method of forming a tension-torsion strap, the method comprising:
arranging a first spindle and a second spindle to have a predefined distance therebetween, the predefined distance and a diameter of each of the first and second spindles, respectively, defining a length of the tension-torsion strap, such that the first and second spindles are positioned at opposite ends of the tension-torsion strap;
wrapping a filament about the first and second spindles a plurality of turns to form a winding, wherein the winding extends between and connects the first and second spindles and is positioned within a cavity formed circumferentially about each of the first and second spindles, and wherein a width of each cavity is defined by lateral walls that are attached to an inner wall of each of the first and second spindles, respectively, and extend radially away from the inner wall to which each such lateral wall is attached; and
covering at least the winding with a protective layer;
wherein the winding is formed according to an arched winding pattern, a portion of the winding extending outside boundaries of the cavity defined by the inner wall and the lateral walls, such that an outer surface of the winding has an arched, or curved, profile.

13. The method of claim 12, wherein the outer surface of the winding is a surface that is not defined by the lateral walls and the inner wall of the spindles.

14. The method of claim 12, comprising, according to the arched winding pattern, winding the filament, for each successively deposited layer of the winding, about the first and second spindles the same or fewer number of turns as an immediately previously deposited layer of the winding.

15. The method of claim 12, comprising, according to the arched winding pattern, winding the filament, for each successively deposited layer of the winding, about the first and second spindles the same or fewer number of turns as all previously deposited layers of the winding.

16. The method of claim 15, wherein each successively deposited layer of the winding is further spaced apart from the inner wall that all previously deposited layers of the winding.

17. The method of claim 12, wherein the tension-torsion strap is inserted in an internal space within a blade-hub coupler on a rotary machine, and wherein the outer surface of the winding has a profile that is substantially similar to an inner surface of the internal space within the blade-hub coupler.

18. The method of claim 17, wherein the rotary machine comprises a helicopter or other rotary-driven aircraft.

19. The method of claim 12, wherein at least a portion of the winding extends radially beyond the sidewalls of one or both of the first and second spindles.

20. The method of claim 12, wherein the protective layer comprises an elastomeric material.

21. The method of claim 12, wherein the protective layer is a molded layer surrounding at least a portion of the first and second spindles and at least a portion of the winding.

22. The method of claim 12, wherein the filament comprises a metallic wire or an organic fiber.
